(19) United States
(12) Patent Application Publication
(10) Pub. No.: US 2002/0166817 A1
(43) Pub. Date: Nov. 14, 2002

(54) Ion exchange media regeneration method for fluid treatment

(75) Inventor: Glenn H. Gruett, New London, WI (US)

Correspondence Address: John M. Manion, RYAN KROMHOLZ & MANION, S.C., Post Office Box 26618, Milwaukee, WI, 53226-0618, US

(73) Assignee: Water-Right, Inc.

(21) Appl. No.: 10/106,871

(22) Filed: Mar. 26, 2002

Related U.S. Application Data
(60) Provisional application No. 60/278,816, filed on Mar. 26, 2001.

(51) Int. Cl. B01D 15/00

(52) U.S. Cl. 210/670

(57) ABSTRACT

An ion exchange method for fluid treatment is disclosed. The method includes steps for supplying, circulating and with withdrawing regenerant fluid to an ion exchange media bed in different sequences, in different flow directions and for different durations of time.

### RELATED APPLICATION

This application claims the benefit of U.S. provisional application serial No. 60/278,816 filed Mar. 26, 2001.

### FIELD OF THE INVENTION

The present invention relates to an ion exchange method for fluid treatment, and in particular to an improved method for regenerating ion exchange media and media beds used in fluid treatment. Ion exchange media processes are commonly used in chemical removal processes. During use, the ion exchange medias must be periodically regenerated or recharged due to complete ion replacement. It is known in the art to pass a regeneration solution through the bed of depleted ion exchange media during which ions are exchanged between the regeneration solution and the depleted media. The media and media bed are then ready for reuse in the process.

As used herein, the terms “ion exchange media” and/or “media” are defined to include resins, zeolites, potassium permanganate or any other chemical used to recharge, reactivate, oxidize, or rejuvenate a material bed. The most common ion exchange media include high capacity ion exchange resins and zeolites. A common ion exchange resin is sulfonated polystyrene resin in the form of spheres or beads. The beads are micro-porous, extremely durable, and insoluble in water and have a negative electrical charge. The standard resin bead is less than approximately 1/32 of an inch in diameter. Zeolite is a naturally occurring hydrated sodium aluminum silicate. Zeolite crystals are also manufactured, for example under the CRYSTAL-RIGHT trademark by Mineral-Right, Inc. of Phillipsburg, Kans. An advantage of zeolite crystals is that they also act as a filter media for removal of particles and turbidity. Potassium permanganate, potassium chloride, hydrogen peroxide, or any other chemical that is known to recharge, reactivate, reoxidize or rejuvenate an ion depleted media may also be utilized as an ion exchange media. If there is any discrepancy between a common definition of the above-noted terms and the definition given herein, both definitions are to apply.

### BACKGROUND OF THE INVENTION

As rain falls through the atmosphere, it may absorb traces of acidic gases in the air, such as carbon dioxide, sulfur oxide, among others. When the natural rainwater reaches the earth's surface, it percolates through the soil and dissolves certain components of the soil due to trace acidity derived from atmosphere acidic gases. The greater the acidity of rainwater, the greater the amount of soil components dissolved. In this way, ground water such as wells and springs, and surface water, such as rivers, lakes and oceans, each contain a certain amount of dissolved matter. Most of the dissolved matter is in the form of electrolytes, which in water form electrically charged ions.

Two commonly occurring ions in natural waters are calcium and magnesium. Each is a positively charged ion, or cation, carrying two unit charges. The presence of these two minerals in natural water causes hardness. Water hardness produces a scum or curd with soap, each of which is difficult to clean from contacting surfaces. Further, hard water reacts with chemical agents such as detergents and thereby reduces the cleaning effectiveness of laundry, dishwashing and bathing. Hard water may also form a hard scaling on the surfaces of metallic plumbing, water heaters, steam irons and even cooking vessels such as pots and pans. The build up of hard water scale can reduce the efficiency of such equipment by requiring greater energy consumption. Calcium and magnesium ions are typically present in natural waters in combination with sulfate, chloride, carbonate, bicarbonate, sodium, potassium, iron and other metallic components, however calcium and magnesium make up the majority of “hard” water.

Typically, hard water may be “softened” by the removal of the water hardening calcium and magnesium ions. One softening method is ion exchange. Softening of water by ion exchange consists essentially of passing hard water through a bed of ion exchange media. The most common ion exchange method is sodium cycle operation, in which calcium and magnesium cations are removed and replaced in solution by sodium. The ion exchange media is initially supersaturated with sodium ions to cover both their exterior and interior surfaces. Since all the ions involved are positively charged, the process is known as positive ion exchange or cation exchange. Negatively charged ions remain in the softened water. The ion exchange media attracts and holds positively charged ions until the media encounters other cations for which they have a greater affinity. At that point the first-attracted cations are re-based and exchanged for the second cations having greater affinity. The exchange rate depends upon the hardness of the water.

In the beginning of the water softening cycle, the ion exchange media is covered with soft sodium (Na+) ions by washing them in a rich sodium chloride brine solution. These media are contained in a pressurized vessel called a media tank. The untreated hard water enters the media tank and passes through the bed of ion exchange media.

The negatively charged ion exchange media have a greater attraction for the two positive charges in each ion of calcium (Ca++) and magnesium (Mg++) than they do for the single positive charge of the sodium (Na+) ion. Therefore, the sodium ions on the ion exchange media will be displaced by the calcium and magnesium ions. In effect, the media exchanges the sodium ions for the calcium and magnesium ions. In other words, the “hard water” ions that enter the media tank are replaced by “soft water” ions that flow from the tank.

Another commonly occurring ion in natural water is iron. The presence of iron in a media bed can lead to the establishment of iron bacteria in a media bed. A chlorine generator can be installed in select regeneration systems. While high doses of chlorine has been shown to cause resin breakdown in some ion exchange media, chlorine can be introduced at requisite levels to synthetic resins, such at zeolite. Chlorine effectively kills iron bacteria in a media bed.

An ion exchange water softener will continue to give soft water only as long as there are sufficient sodium ions remaining in the media beads. After a vast number of calcium and magnesium ions from the “hard water” have become attached to the ion exchange media, the media becomes saturated with calcium and magnesium ions. As the ion exchange media has become exhausted, it must now be regenerated or recharged.

A drawback of regeneration is that the water softener cannot perform its softening function during regeneration. Accordingly, there exists a need for an ion exchange method that can be regenerated efficiently, thereby minimizing the number of times the system must be regenerated. There further exists a need for an ion exchange method that can efficiently regenerate the ion exchanger thereby maximizing the amount of water that can be processed or “softened” before subsequent regeneration. Additionally, the fluid passed over the media bed during regeneration must be discarded, therefore there exists a need to minimize the amount of fluid that must be passed over the media bed during regeneration. Further, there exists a need to maximize the length of time between regenerations, that is, the amount of water able to be passed over the media bed between regenerations.

The biggest drawback of regeneration is sodium consumption. It is known in the art to use a “high salt” setting to maximize the amount of time between regeneration cycles. This however leads to high salt consumption. Alternately, it is known to use a “low salt” setting to reduce salt consumption. A low salt setting will require more frequent regeneration. There exists a need an efficient means of regeneration whereby a maximum amount of water can be softened using a minimal amount of sodium.

Another significant drawback of present regeneration systems, especially those systems used in households with a well, is that these systems typically use an injector relying on household water pressure to draw the regenerant or brine solution into the media tank. An injector can create a channel in the ion exchange media bed thereby preventing any upflowed regenerating fluid from flowing evenly through the bed. The present invention utilizes a pump that is not dependant upon household water pressure to maximize the efficiency of the system.

It is known in the art to utilize a pump when recharging or regenerating media tanks at a commercial facility. Practicing theses prior art techniques includes pumping regenerant solution from a holding tank into a media tank and then pumping the regenerant solution back into the holding tank. It is also known to pump the regenerant solution from a holding tank into a first media tank, from the first media tank into a second media tank, from the second media tank into a third media tank, from the third media tank into a forth media tank and so forth until the regeneration solution is either returned to the holding tank or disposed of. The present invention is unique in that the regenerant solution is recirculated with a pump within the media tank of a non-commercial or residential fluid treatment system.

### SUMMARY OF THE INVENTION

The present invention comprises an improved method for regenerating beds of ion exchange media to effectively and efficiently regenerate the entire media bed, thereby maximizing the total fluid gallons between regenerations. Due to the high efficiencies obtained, the length of time between required regenerations is maximized.

Specifically, the present invention comprises an improved method for regenerating ion exchange media, wherein a regenerating fluid is circulated and recirculated with the use of a pump through a bed of unregenerated or exhausted ion exchange media and ions are exchanged between the fluid and the media, thereby forming regenerated ion exchange media and media beds. The regenerating fluid is pumped or circulated and recirculated in different directions and at different flow rates and times.

It is an object of the present invention to provide improved methods of regenerating ion exchange media by downward or current regenerant fluid flow.

It is an object of the present invention to provide improved methods of regenerating ion exchange media by upward or counter-current regenerant fluid flow by pump.

Another object is to reduce the amount of regenerant fluid that must be disposed of as waste liquid.

Another object is to fully utilize the regenerant fluid.

Another object is to fully utilize the exchange media between regenerations in an ion exchange application.

Another object, specific to upflow regeneration is to preserve the compaction of the ion exchange media to insure ion exchange efficiency.

A further object is to minimize the upset or expulsion of the ion exchange media bed during upflow or countercurrent regeneration.

Yet another object is to provide efficient, relatively low cost methods for upflow or downflow regeneration of ion exchange media that employs simple, easily controlled mechanical devices.

Yet another object is to provide a low cost system that can be used in a residential or light commercial application.

These and other objects of the invention will be apparent in the descriptions that follow.

### DESCRIPTION OF THE DRAWING

FIG. 1 is a schematic representation of the backwash cycle.

FIG. 2 is a schematic representation of the initial addition of regenerant cycle.

FIG. 3 is a schematic representation of the regenerant pump cycle.

FIG. 4 is a schematic representation of the pause cycle.

FIG. 5 is a schematic representation of the regenerant recirculated cycle.

FIG. 6 is a schematic representation of the regenerated rinsed cycle.

FIG. 7 is a schematic representation of the rapid rinse cycle.

FIG. 8 is a schematic representation of the regenerant refill cycle.

FIG. 9 is a schematic representation of the service cycle.

### DETAILED DESCRIPTION

Although the disclosure hereof is detailed and exact to enable those skilled in the art to practice the invention, the physical embodiments herein disclosed merely exemplify the invention that may be embodied in other specific structure. While the preferred embodiment has been described, the details may be changed without departing from the invention, which is defined by the claims.

In the drawings, a pressure vessel 10 contains a bed 12 of ion exchange media 14. A control mechanism 16 is attached to the top 9 of the pressure vessel 10 and controls the flow of various fluids into and out of the pressure vessel 10. The control mechanism 16 includes a pump mechanism p and one or more valves V. A stand pipe 18 having a proximal end 20 and distal end 22 is located between the pressure vessel 10 and the control mechanism 16, with the proximal end 20 being attached to the control mechanism 16 and the distal end 22 extending into the pressure vessel 10. The distal end 22 preferably extends to substantially the bottom 11 of the pressure vessel 10.

Regenerant fluid 24 is supplied to the pressure vessel 10 from a regenerant supply 30. Tubing 32 connects the supply vessel 30 to the control mechanism 16. An inlet 40 for untreated or hard water is provided. There is also an outlet 42 for treated or softened water. The control mechanism further includes another outlet port 44 connected to a drain 46.

When the ion removing capacity of the ion exchange media 14 in the bed 12 diminishes to a predetermined level, the bed 12 must be regenerated. In the first sequence of the regeneration cycle, the media bed 12 is backwashed. During backwashing, water from the hard water inlet 40 under regulated pressure is passed through the media bed 12 in the opposite direction of normal flow. The flow is from the tank bottom 11 to the tank top 9 and is commonly called up-flow or counter-flow.

Referring to FIG. 1, water is passed through stand pipe 18 to the bottom 11 of the pressure vessel 10. The water then rises to the top of the media bed 12 where it is siphoned away. This process flushes suspended matter from the media tank 10 thereby reducing the possibility of fouling the media bed 12. The media bed often becomes compacted during the softening or service cycle. Backwashing also loosens the media bed 12 to allow for better and more efficient ion exchange during the regeneration process.

In the regeneration process, the ion exchange media 14 is washed with a strong solution of salt water, known as brine solution. Although the media 14 has a greater affinity to the calcium and magnesium ions which each have two positive charges, the overwhelming concentration of sodium ions overcomes this affinity. The sodium ions in the brine solution force the calcium and magnesium ions off the media 14 to be ultimately discharged as waste through the drain 46.

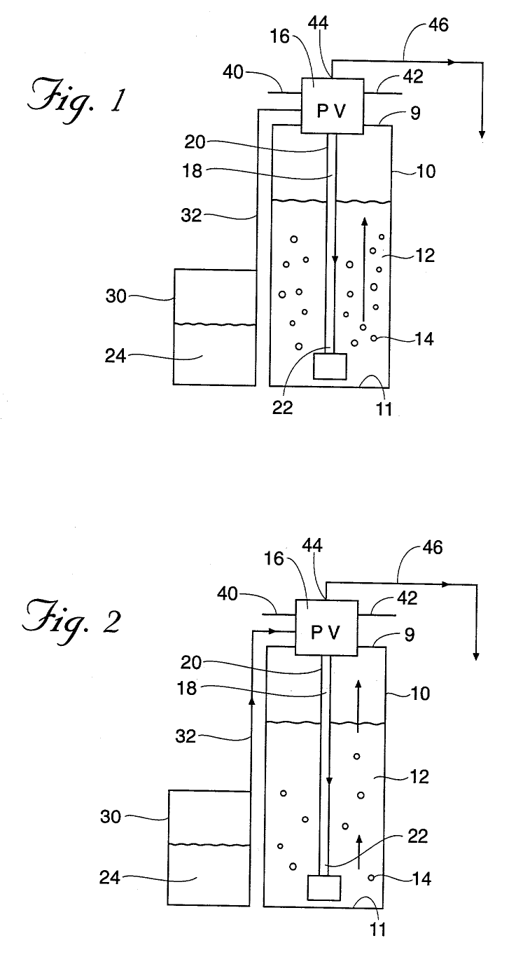

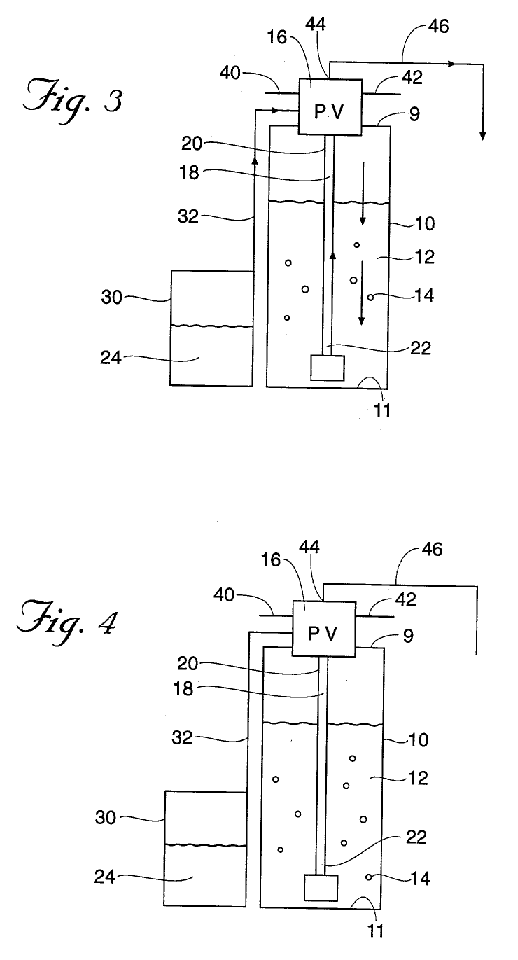

As shown in FIG. 2, regenerant fluid 24 is initially up-flowed through the media bed 12 by pumping the fluid 24 with pump p through the stand pipe 18 and siphoning the fluid 24 from the top 9 of the pressure vessel 10. Alternatively, the regenerant fluid 24 may be down-flowed through the media bed.

Now referring to FIG. 3, after the regenerant fluid 24 has been up-flowed or down-flowed for a predetermined period of time, the fluid 24 is then down-flowed through the media bed 12. Again, the pump P is utilized to draw fresh regenerant fluid 24 from the regenerant supply 30. The spent regenerant fluid 24 is withdrawn from the bottom 11 of the pressure vessel 10 by the stand pipe 18 distal end 22.

While not required to practice the invention, a pause cycle may be incorporated into the regeneration process. The pause cycle, as shown in FIG. 4, allows the ion exchange media 14 to stagnantly soak in the regenerant solution 24 for a predetermined time period. At the end of the pause cycle, the fluid 24 begins to flow again.

Also while not required to practice the invention, a preliminary rinse cycle may be incorporated into the regeneration process. The preliminary rinse cycle is identical to the cycle shown in FIG. 7. During the preliminary rinse, a predetermined portion of the regenerant solution is discharged to the outlet port 44 and drain 46. It has been found that the first portion of the regenerant solution that is passed through the ion exchange bed 12 becomes “fouled” with sediment and other impurities within the ion exchange bed 12. By purging this predetermined amount of regenerant fluid from the media tank 10, the effectiveness of the next step is greatly improved.

Next, and as shown in FIG. 5, the regenerant fluid 24 is recirculated through the pressure vessel 10. The pump P and valve assembly V are utilized to redirect the fluid 24 through the media bed 12. Regenerant fluid flow can occur in the up-flow or the down-flow direction or both. Recirculating the regenerant fluid 24 in the pressure vessel 10 has been shown to increase the system efficiency by approximately twenty percent (20%).

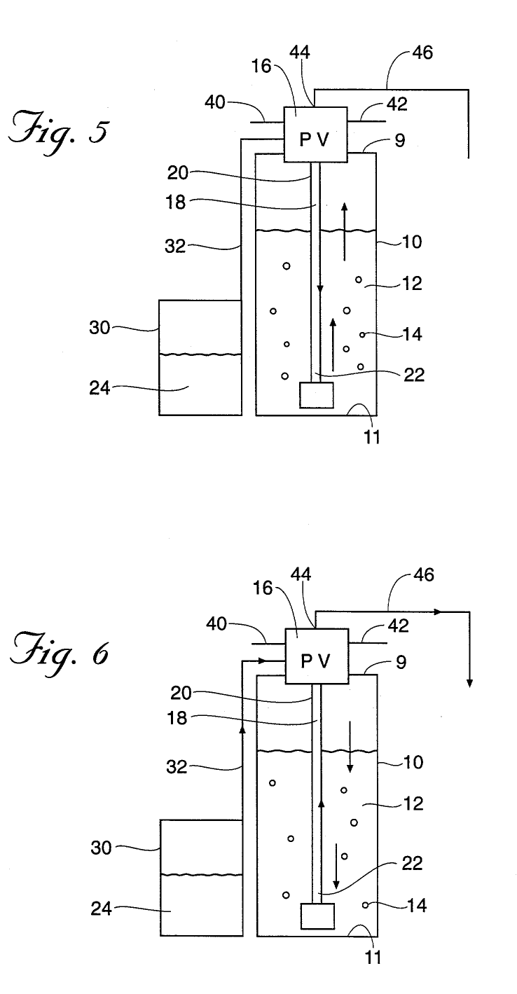

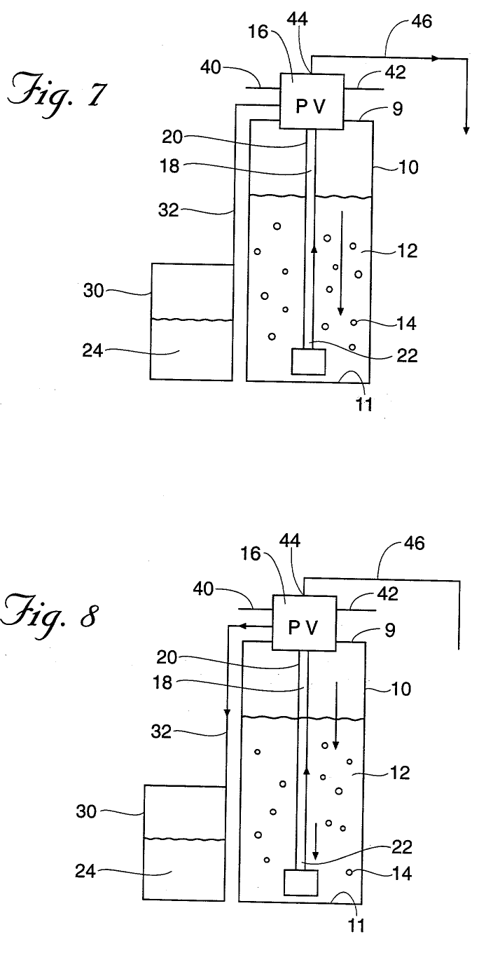

The recirculated regenerant fluid 24 is then rinsed from the system by withdrawing it from the pressure vessel 10 as shown in FIG. 6. When the recirculated regenerant 24 has been removed, additional regenerant 24 may be added to the pressure vessel 10 if necessary to insure that a complete ion exchange has occurred. The additional regenerant 24 may be up-flowed or down-flowed through the pressure vessel 10 by means of the pump P and valve assembly V.

Now referring to FIG. 7, the media bed 12 is then rinsed to remove the excess regenerant solution 24 from the pressure vessel 10. The ion exchange media 14 is then ready to produce soft water again.

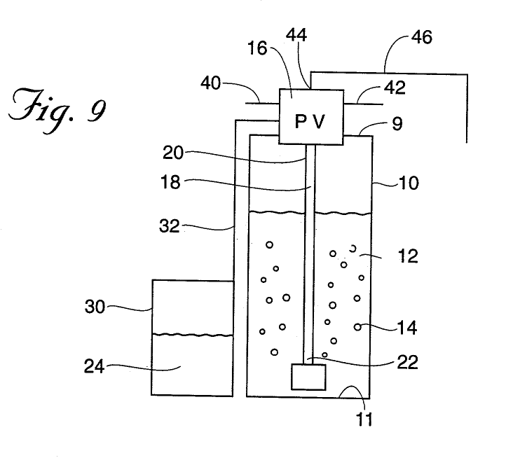

Prior to returning to the service mode and as shown in FIG. 8, a small predetermined amount of hard water is down-flowed through the pressure vessel (i.e. softened), drawn up through the stand pipe 18 and pumped into the regenerant supply vessel 30. This fluid mixes with the material in the regenerant supply 30, typically a brine tank housing, but not limited to salt (NaCl). This process creates the regenerant fluid 24 to be used during the next regeneration cycle.

Ultimately, the system is returned to the service mode as shown in FIG. 9. The frequency of the regeneration process is determined by the capacity of the softener, the hardness of the water and water usage.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention that is defined by the claims.

What is claimed is:

1. A method for regenerating a media comprising the steps of:
backwashing the media;
flowing a regenerant fluid through the media in a first fluid flow direction;
recirculating the regenerant fluid through the media;
withdrawing the regenerant fluid from the media; and
rinsing the media.

2. The method of claim 1 wherein the media is ion exchange media.

3. A method for regenerating a media comprising the steps of:
backwashing the media;
flowing a regenerant fluid through the media in a first fluid flow direction;
recuirculating the regenerant fluid through the media in a second fluid flow direction;
withdrawing the regenerant fluid from the media; and
rinsing the media.

4. The method of claim 3 wherein the media is ion exchange media.

5. A method for regenerating a media comprising the steps of:
backwashing the media;
flowing a regenerant fluid through the media in a first fluid flow direction;
recirculating the regenerant fluid through the media in the first fluid flow direction;
withdrawing the regenerant fluid from the media; and
rinsing the media.

6. The method of claim 5 wherein the media is ion exchange media.

7. A method for regenerating a media comprising the steps of:
backwashing the media;
flowing a regenerant fluid through the media;
pausing the flow of regenerant fluid through the media for a predetermined period of time;
recirculating the regenerant fluid through the media;
withdrawing the regenerant fluid from the media; and
rinsing the media.

8. The method of claim 7 wherein the media is ion exchange media.

9. A method for regenerating a media comprising the steps of:
backwashing the media;
flowing a regenerant fluid through the media;
removing a predetermined amount of regenerant fluid from the media;
recirculating the regenerant fluid through the media;
withdrawing the regenerant fluid from the media; and
rinsing the media.

10. The method of claim 9 wherein the media is ion exchange media.

11. A method for regenerating a media comprising the steps of:
backwashing the media;
flowing a regenerant fluid through the media in a first fluid flow direction;
recirculating the regenerant fluid through the media in a second fluid flow direction;
withdrawing the regenerant fluid from the media;
flowing a second regenerant fluid through the ion exchange media;
withdrawing the second regenerant fluid from the media; and
rinsing the media.

12. The method of claim 11 wherein the media is ion exchange media.

13. A method for regenerating a media comprising the steps of:
backwashing the media;
flowing a regenerant fluid through the media in a first fluid flow direction;
recirculating the regenerant fluid through the media;
withdrawing the regenerant fluid from the media;
flowing a second regenerant fluid through the media in a second fluid flow direction;
withdrawing the second regenerant fluid from the media; and
rinsing the media.

14. The method of claim 13 wherein the media is ion exchange media.

15. A method for regenerating a media comprising the steps of:
backwashing the media;
flowing a regenerant fluid through the media in a first fluid flow direction;
recirculating the regenerant fluid through the media;
withdrawing the regenerant fluid from the media;
flowing a second regenerant fluid through the media in the first fluid flow direction;
recirculating the regenerant fluid through the media;
withdrawing the second regenerant fluid from the media; and
rinsing the media.

16. The method of claim 15 wherein the media is ion exchange media.
